(19) United States
(12) Patent Application Publication
(10) Pub. No.: US 2017/0080860 A1
(43) Pub. Date: Mar. 23, 2017

(54) REAR-VIEW CONFIRMATION DEVICE AND AUTOMOBILE EQUIPPED WITH SAME

(71) Applicant: Panasonic Intellectual Property Management Co., Ltd., Osaka (JP)

(72) Inventor: MASAMI YODA, Kanagawa (JP)

(21) Appl. No.: 15/126,273

(22) PCT Filed: Apr. 2, 2015
(86) PCT No.: PCT/JP2015/001888

§ 371 Date: Sep. 14, 2016

(30) Foreign Application Priority Data
Apr. 7, 2014 (JP) 2014-078339
Jun. 20, 2014 (JP) 2014-126898

(51) Int. Cl. B60R 1/00; H04N 7/18; B60R 11/02

(52) U.S. Cl. CPC B60R 1/00; B60R 11/0235; H04N 7/183; B60R 2300/8046

(57) ABSTRACT

The present invention includes a display device, a mounting member, and a camera device. The mounting member includes a pivot disposed inside a body case. A rotation holding mechanism installed inside the body case includes a holding part disposed on a side surface of the pivot, an urging part for urging the holding part toward the pivot, a coupling part coupled to the urging part and configured to release urging of the urging part toward the pivot, and an operating part coupled to the coupling part and urged from an inside of the body case to an outside of the body case by the coupling part. The operating part can perform push operation from the outside of the body case to the inside of the body case via an operation opening provided in at least one of upper and lower portions of the body case.

### TECHNICAL FIELD

The present invention relates to a rear-view confirmation device also referred to as a rear-view mirror in an automobile, for example, and an automobile equipped with the same.

### BACKGROUND ART

For example, as a rear-view confirmation device also referred to as a rear-view mirror in an automobile, a device for projecting a rear video image captured by a camera device has been proposed.

In other words, the rear-view confirmation device includes a display device mounted in front of a driver's seat in an interior of the automobile and the camera device connected to the display device and capable of capturing the rear video image of the automobile. Also, the rear video image captured by the camera device is displayed on the display device (PTL 1 listed in Citation List below discloses a similar technique).

In the aforementioned rear-view confirmation device, since a display is contained in a body case of the display device, a weight of the display device increases. As a result, a setting position to a driver may be displaced by a vibration or an impact during driving of an automobile.

Therefore, there is known a technique in which a holding part of a rotation holding mechanism is urged by an urging part to a pivot of a mounting member for mounting a display device on a front side of an automobile, so that displacement of a body case of the display device from a setting position to a driver due to a vibration or an impact is suppressed (PTL 2 listed in Citation List below discloses a similar technique).

### CITATION LIST

### Patent Literatures

PTL 1: Unexamined Japanese Patent Publication No. 2013-244752

PTL 2: Unexamined Japanese Patent Publication No. 2003-146135

### SUMMARY OF THE INVENTION

A rear-view confirmation device according to one aspect of the present invention includes a display device mounted in front of a driver's seat in an interior of an automobile, a mounting member for mounting the display device in the front of the driver's seat, and a camera device connected to the display device and capable of capturing a rear video image of the automobile. Also, the display device includes a body case having an opening on a driver's seat side, a display disposed so as to cover the opening of the body case, and a rotation holding mechanism installed inside the body case. Further, the mounting member includes a pivot disposed inside the body case. Further, the rotation holding mechanism includes a holding part disposed on a side surface of the pivot, an urging part for urging the holding part toward the pivot, a coupling part coupled to the urging part, and configured to release urging of the urging part toward the pivot, and an operating part coupled to the coupling part and urged from an inside of the body case to an outside of the body case by the coupling part. Also, the operating part is capable of performing push operation from the outside of the body case to the inside of the body case via an operation opening provided in at least one of upper and lower portions of the body case.

Further, a rear-view confirmation device according to another aspect of the present invention includes a display device mounted in front of a driver's seat in an interior of an automobile, a mounting member for mounting the display device in the front of the driver's seat, and a camera device connected to the display device and capable of capturing a rear video image of the automobile. Also, the display device includes a body case having an opening on a driver's seat side, a display disposed so as to cover the opening of the body case, and a rotation holding mechanism installed inside the body case. Further, the mounting member includes a pivot disposed inside the body case. Further, the rotation holding mechanism includes a holding part disposed in at least one of upper and lower portions of the pivot, an urging part for urging the holding part toward the pivot, and an operating part coupled to the urging part and urged from an inside of the body case to an outside of the body case by the urging part. Further, the urging part includes an operating lever having a first end coupled to the operating part and a second end inserted into the body case, a first coupling lever having a first end axially supported by the second end of the operating lever, and a second coupling lever having a first end axially supported by the second end of the operating lever. Also, a middle portion of the first coupling lever and a middle portion of the second coupling lever are axially supported by the body case, and the second end of the first coupling lever and the second end of the second coupling lever are axially supported by the holding part.

The rear-view confirmation device of the present invention is extremely easy to use according to the above-described configuration.

### BRIEF DESCRIPTION OF DRAWINGS

FIG. 1 is a front view showing an interior of an automobile equipped with a rear-view confirmation device according to a first exemplary embodiment of the present invention.

FIG. 2 is a plan view of the automobile equipped with the rear-view confirmation device according to the first exemplary embodiment of the present invention.

FIG. 3 is a sectional view of the automobile equipped with the rear-view confirmation device according to the first exemplary embodiment of the present invention.

FIG. 4 is a front view showing a body case of the rear-view confirmation device according to the first exemplary embodiment of the present invention.

FIG. 5 is a block diagram of a display device and a camera device of the rear-view confirmation device according to the first exemplary embodiment of the present invention.

FIG. 6 is a flowchart showing operations of the rear-view confirmation device according to the first exemplary embodiment of the present invention.

FIG. 7 is a timing chart of the rear-view confirmation device according to the first exemplary embodiment of the present invention.

FIG. 8 is a perspective view showing the body case of the rear-view confirmation device according to the first exemplary embodiment of the present invention.

FIG. 9 is a perspective view showing an inside of the body case of the rear-view confirmation device according to the first exemplary embodiment of the present invention.

FIG. 10 is a front view showing the inside of the body case of the rear-view confirmation device according to the first exemplary embodiment of the present invention.

FIG. 11 is an enlarged sectional view showing a portion of the body case of the rear-view confirmation device according to the first exemplary embodiment of the present invention.

FIG. 12 is a front view showing an inside of a body case of a rear-view confirmation device according to a second exemplary embodiment of the present invention.

FIG. 13 is an enlarged sectional view showing a portion of the body case of the rear-view confirmation device according to the second exemplary embodiment of the present invention.

FIG. 14 is a front view showing an inside of the body case of the rear-view confirmation device according to the second exemplary embodiment of the present invention.

### DESCRIPTION OF EMBODIMENTS

A problem of a conventional rear-view confirmation device found by the inventors is described prior to description of exemplary embodiments.

In the conventional rear-view confirmation device described above, a holding part of a rotation holding mechanism is urged by an urging part to a pivot of a mounting member for mounting on a front side of an automobile. Accordingly, displacement of a body case of a display device from a setting position to a driver caused by a vibration or an impact can be suppressed.

Further, when the driver changes the setting position of the body case of the display device, the setting position of the body case is changed after operation of an urge release lever provided below the body case. Then, the urge release lever is return-operated again.

However, in a case where the setting position is changed in the conventional rear-view confirmation device, the device is extremely hard to use as described below. The driver searches the urge release lever provided below the body case during driving of the automobile, and then operates the lever in a front-back direction. Thereafter, the driver moves his/her operating hand and grips upper and lower portions of the body case to change the setting position. Then, the driver must return the urge release lever again after moving his/her operating hand.

Therefore, an object of the present invention is to make a rear-view confirmation device easy to use.

### First Exemplary Embodiment

An example of an automobile equipped with a rear-view confirmation device according to a first exemplary embodiment of the present invention is described below with reference to the drawings. It should be noted that in the following exemplary embodiments, identical reference marks are assigned to identical configurations, and description thereof may be omitted.

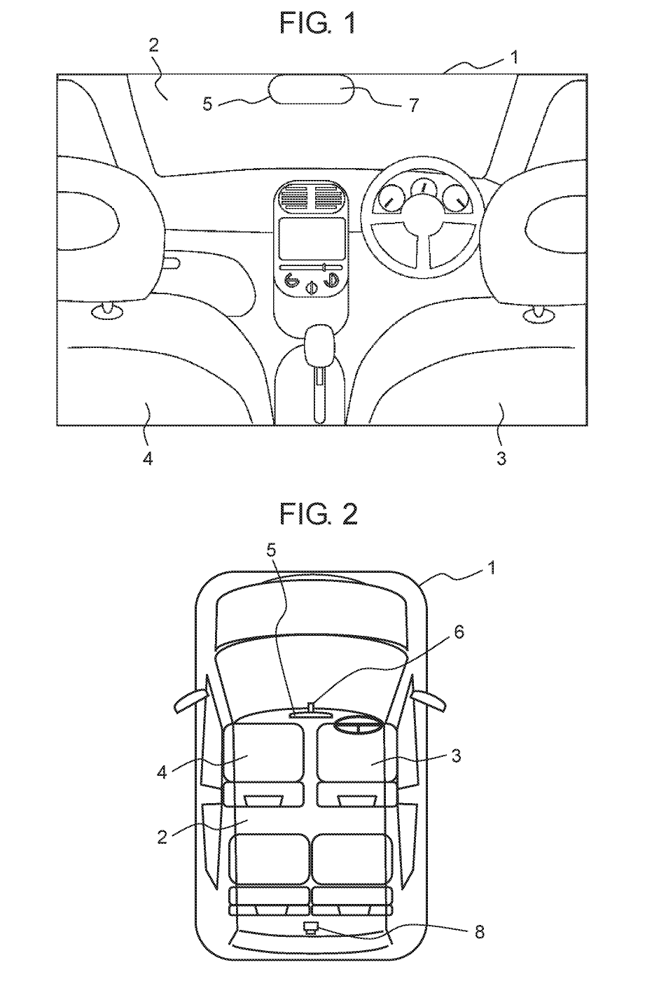

As shown in FIGS. 1 to 4, the rear-view confirmation device of the present exemplary embodiment includes display device 5, mounting member 6, and camera device 8. Display device 5 is mounted on a front side of interior 2 of automobile 1 between driver's seat 3 and assistant driver's seat 4. It is preferable that display device 5 be mounted forward and upward of interior 2 of automobile 1 between driver's seat 3 and assistant driver's seat 4. It is possible to vary an inclination state of display device 5 with respect to mounting member 6. Display device 5 includes operating part 15 (shown in FIG. 4).

Body case 5A of display device 5 has a shape of a container opened on a driver's seat 3 side. Display opening 5B having an opening is installed in body case 5A. Also, display 7 is disposed inside the opening of display opening 5B.

It should be noted that, since a configuration of display device 5 is described below in detail, detailed description of display device 5 is omitted herein.

### [Operations of Display Device 5 and Camera Device 8]

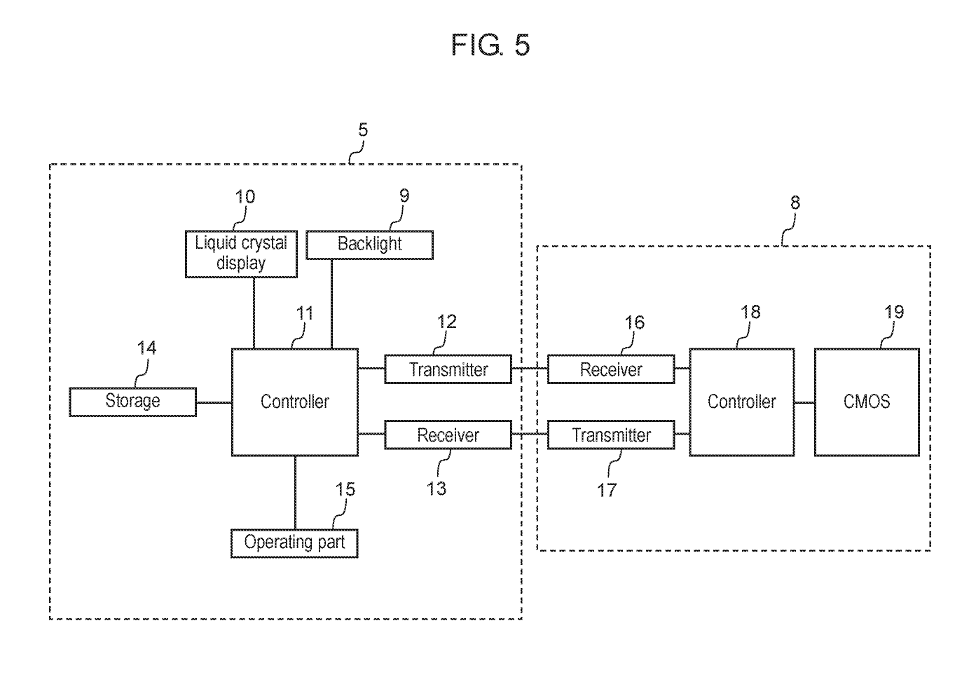

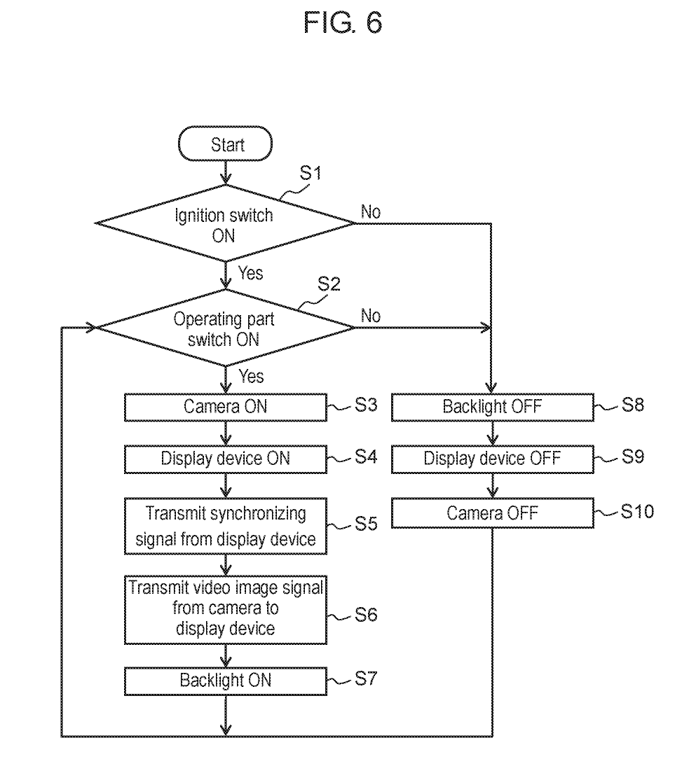

Next, operations of display device 5 and camera device 8 are described with reference to FIGS. 5 to 7.

As shown in FIG. 5, display device 5 projects a video image from camera device 8 capable of capturing a rear video image of automobile 1.

First, a configuration of the display device is described. As shown in FIG. 5, display device 5 includes backlight 9, liquid crystal display 10 (one example of display 7), controller 11, transmitter 12, receiver 13, storage 14, and operating part 15. Backlight 9 is disposed inside display device 5, and liquid crystal display 10 (the one example of display 7) is disposed on the driver's seat 3 side. Controller 11 is connected to backlight 9 and liquid crystal display 10. Transmitter 12, receiver 13, storage 14, and operating part 15 are connected to controller 11.

It should be noted that storage 14 stores an operation program, and operating part 15 turns a power supply switch ON or OFF.

Further, camera device 8 includes receiver 16, transmitter 17, controller 18, and imaging element 19. Receiver 16 is connected to transmitter 12 of display device 5, and transmitter 17 is connected to receiver 13 of display device 5. Further, receiver 16, transmitter 17, and imaging element 19 are connected to controller 18.

As described below in detail, it should be noted that controller 11 of display device 5 transmits a synchronizing signal to controller 18 of camera device 8 via transmitter 12 and receiver 16. Further, controller 18 of camera device 8 transmits a video image signal to controller 11 of display device 5 via transmitter 17 and receiver 13 upon reception of this synchronizing signal.

As described above, display device 5 sequentially transmits the video image signal from controller 11 to liquid crystal display 10 (display 7), thereby displaying a video image.

It should be noted that, in the present exemplary embodiment, imaging element 19 is configured by a CMOS (Complementary Metal-Oxide Semiconductor) sensor.

Next, the operations of display device 5 and camera device 8 are described with reference to FIGS. 5 to 7.

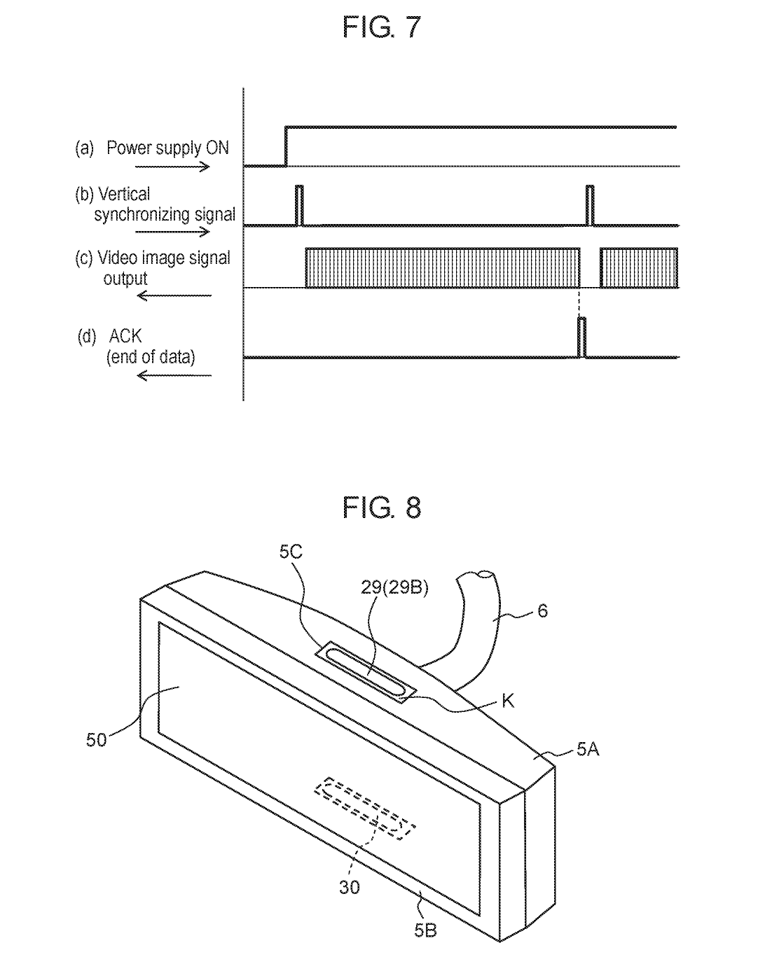

First, an ignition switch (not shown) of automobile 1 is turned ON (S1). Next, operating part 15 (see FIG. 4) is operated to turn the power supply switch ON (S2). Then, power is supplied to camera device 8 and display device 5, and camera device 8 and display device 5 are started (S3, S4). As shown in (a) of FIG. 7, the power supply is turned ON.

Then, when camera device 8 and display device 5 are started, as shown in (b) of FIG. 7, controller 11 of display device 5 transmits the synchronizing signal (vertical synchronizing signal) to controller 18 of camera device 8 via transmitter 12 and receiver 16 (S5).

Subsequently, as shown in (c) of FIG. 7, controller 18 of camera device 8 transmits the video image signal to controller 11 of display device 5 via transmitter 17 and receiver 13 upon reception of the synchronizing signal from controller 11 of display device 5 (S6).

Then, when controller 11 of display device 5 receives the video image signal from controller 18 of camera device 8, controller 11 turns backlight 9 ON, and sequentially supplies the video image signal to liquid crystal display 10 of display device 5, thereby displaying the video image (S7).

Further, as shown in (d) of FIG. 7, controller 18 of camera device 8 transmits a transmission completion signal of one frame of the video image to controller 11 of display device 5 via transmitter 17 and receiver 13 at the end of the one frame of the video image signal prepared by camera device 8.

Next, controller 11 of display device 5 transmits a subsequent synchronizing signal (a vertical synchronizing signal) to controller 18 of camera device 8 via transmitter 12 and receiver 16. The same operations described above are repeated hereafter.

In other words, controller 11 of display device 5 transmits the synchronizing signal to controller 18 of camera device 8 via transmitter 12 and receiver 16, controller 18 of camera device 8 transmits the video image signal to controller 11 of display device 5 via transmitter 17 and receiver 13, and then controller 11 transmits the video image signal to liquid crystal display 10.

With this configuration, one frame screen is not formed by display device 5. As a result, a time delay between a displayed video image and an actual video image is reduced. Accordingly, the device gives less uncomfortable feeling to a driver and is easy to use.

Further, when operating part 15 (shown in FIG. 4) is operated to turn the power supply switch OFF (S2), backlight 9 is turned OFF (S8). Moreover, power supply to display device 5 and camera device 8 is cut off, and both display device 5 and camera device 8 are turned OFF (S9, S10).

It should be noted that since imaging element 19 in the present exemplary embodiment is configured by the CMOS sensor having 330 thousand pixels, the delay of the displayed video image from the actual video image can be further reduced by utilizing only an inner area, that is, by reducing a number of utilized pixels.

As described above, the rear-view confirmation device of the present exemplary embodiment is extremely easy to use due to the reduction of the video image delay. However, in order to properly use the rear-view confirmation device described above, it is important to set an angle of the device relative to the driver. A point regarding the angle setting is the largest characteristic of the present exemplary embodiment.

### [Details of Configuration of Display Device 5]

Next, a configuration of display device 5 of the present exemplary embodiment is described in detail with reference to FIGS. 8 to 10.

As shown in FIG. 8, display device 5 includes body case 5A opened on the driver's seat 3 side, display opening 5B, and display 7 (not shown in FIG. 8). Display 7 is installed in display opening 5B so as to cover opening 50 of body case 5A (see FIG. 4).

It should be noted that body case 5A and display opening 5B are formed as separate members as described in the present exemplary embodiment. However, the body case may be obtained by integrally forming body case 5A and display opening 5B. Further, it is not necessary to form display opening 5B, and only body case 5A may be provided. In this case, display 7 may be disposed inside opening 50 of body case 5A. Further, as in the present exemplary embodiment, display opening 5B may be regarded as a part of the body case in a structure in which case 5A and display opening 5B are formed as separate members.

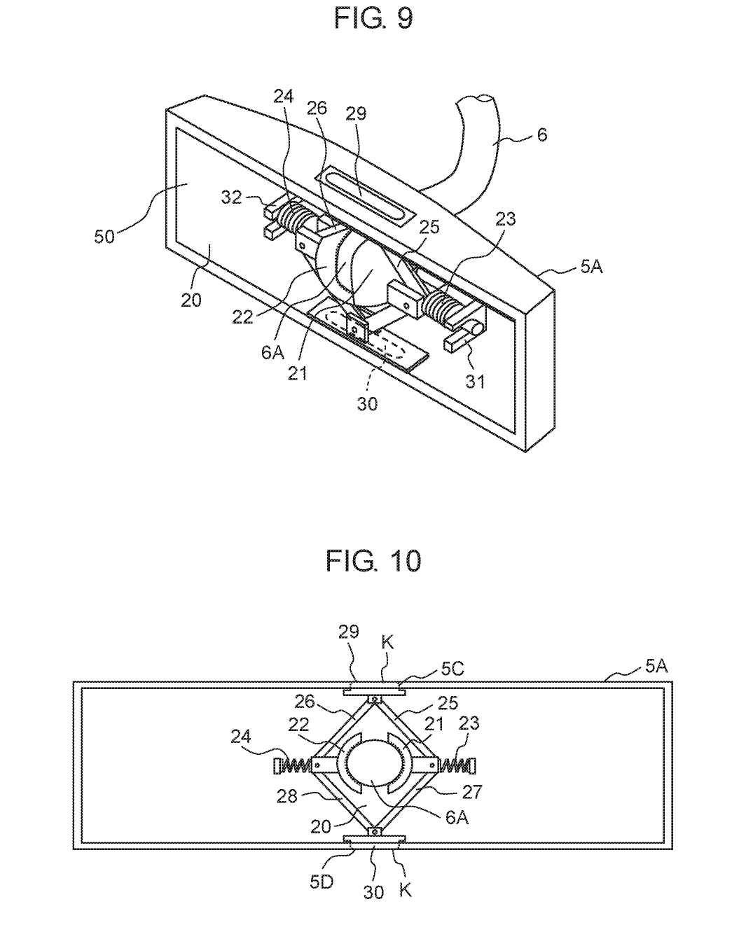

Moreover, as shown in FIG. 9, rotation holding mechanism 20 is installed inside body case 5A.

Further, as shown in FIG. 10, mounting member 6 includes substantially spherical pivot 6A disposed inside body case 5A.

### [Configuration of Rotation Holding Mechanism 20]

First, rotation holding mechanism 20 is described with reference to FIGS. 9 and 10.

Rotation holding mechanism 20 of the present exemplary embodiment includes holding parts 21, 22, urging parts 23, 24, coupling parts 25 to 28, and operating parts 29, 30.

Holding parts 21, 22 each having a shape of a curved container (a hemispherical shape) are disposed on both right and left sides of pivot 6A. Urging parts 23, 24 respectively urge holding parts 21, 22 toward pivot 6A. Coupling parts 25, 26 (first coupling parts) are extended upward and coupled to urging parts 23, 24. Further, coupling parts 27, 28 (second coupling parts) are extended downward and coupled to urging parts 23, 24. Operation opening 5C (an upward operation opening) is provided in an upper portion of body case 5A, and operation opening 5D (a downward operation opening) is provided in a lower portion of body case 5A. Operating part 29 (the upward operation opening) is coupled to coupling parts 25, 26, and can be vertically operated by penetrating through operation opening 5C in the upper portion of body case 5A. Further, operating part 30 (the downward operation opening) is coupled to coupling parts 27, 28, and can be vertically operated by penetrating through operation opening 5D in the lower portion of body case 5A.

It should be noted that regulating parts 31, 32 are configurations for moving urging parts 23, 24 in a horizontal direction.

In rotation holding mechanism 20 configured as described above, operating part 29 is urged upward by urging parts 23, 24 via coupling parts 25, 26. Further, operating part 30 is urged downward by urging parts 23, 24 via coupling parts 27, 28.

Moreover, in the present exemplary embodiment, it is preferable that a rough surface be provided on at least one of a surface of pivot 6A which faces holding parts 21, 22 and surfaces of holding parts 21, 22 which face pivot 6A.

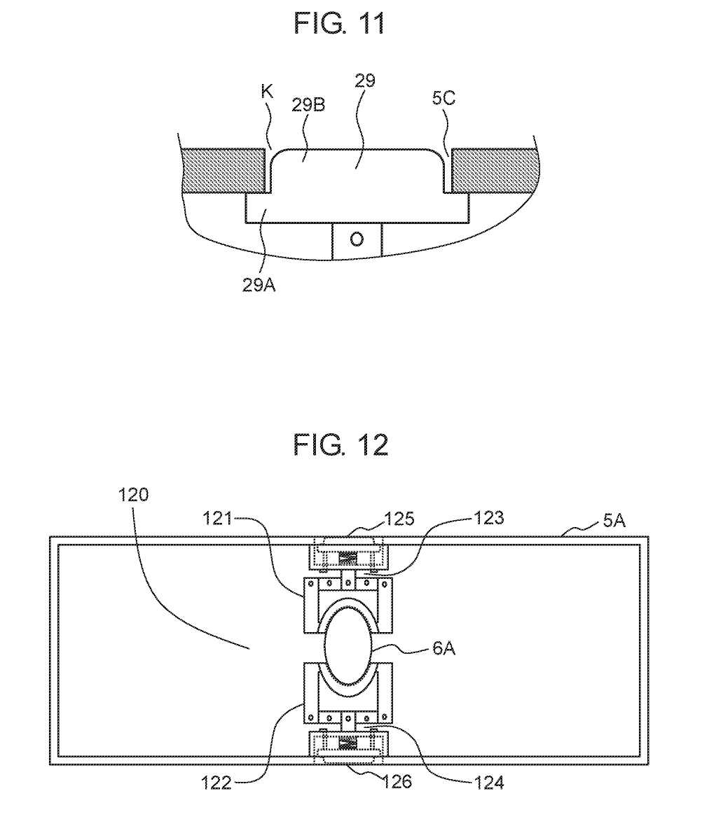

Moreover, as shown in FIG. 11, at least one of operating parts 29, 30 has large diameter portion 29A located inside body case 5A and small diameter portion 29B. Small diameter portion 29B is coupled to large diameter portion 29A, and protrudes from an inside of body case 5A by penetrating through operation opening 5C. Also, an outer peripheral surface of small diameter portion 29B is a curved surface. Moreover, there is gap K between inner peripheral surface of operation opening 5C and small diameter portion 29B.

The driver can recognize a position of operating part 29 by gap K.

### [Operation of Display Device 5]

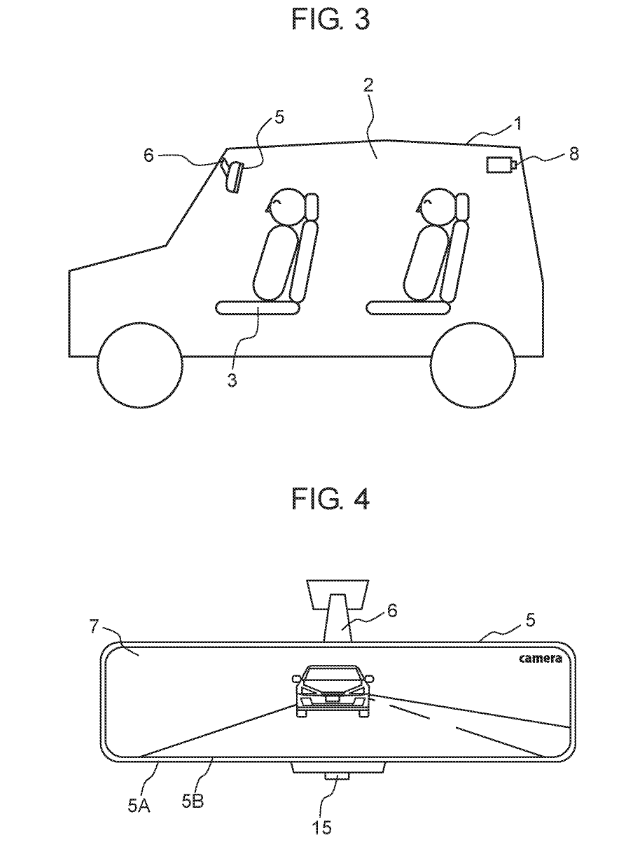

Next, operation of display device 5 is described with reference to FIGS. 3, 4, 9, and 10.

When the angle of display device 5 relative to the driver is set, body case 5A of display device 5 is gripped with one hand from the driver's seat 3 side.

In other words, when the angle setting is performed, for example, a thumb of the hand is placed on operating part 30, a middle finger of the hand is placed on operating part 29, and operating part 30 and operating part 29 are pushed toward the inside of body case 5A.

At this time, since gap K for recognizing an operating part is formed between operating part 29 and the inner peripheral surface of operation opening 5C and between operating part 30 and an inner peripheral surface of operation opening 5D, gap K for recognizing an operating part can be easily found by touch. In other words, the driver can easily find operating parts 29, 30 and then push operating parts 29, 30 toward the inside of body case 5A even during driving of the automobile.

When operating parts 29, 30 are pushed toward the inside of body case 5A, urging parts 23, 24 are compressed and moved in directions away from pivot 6A (outward) by coupling parts 25, 26 coupled to operating part 29 and coupling parts 27, 28 coupled to operating part 30.

As a result, holding parts 21, 22 which abut on pivot 6A are also moved in the directions away from pivot 6A (outward). Accordingly, body case 5A can be freely rotated relative to pivot 6A, and the angle of display device 5 relative to the driver can be easily set.

Then, when the angle setting of display device 5 ends, the hand which grips body case 5A is released. Urging parts 23, 24 are moved in directions toward pivot 6A, and holding parts 21, 22 are pressed against pivot 6A again. Then, body case 5a is not easily moved by a vibration or an impact again.

At this time, operating part 29 is moved upward by coupling parts 25, 26 (the first coupling parts), and operating part 30 is moved downward by coupling parts 27, 28 (the second coupling parts). Accordingly, operating parts 29, 30 are returned to an original state shown in FIG. 10.

In other words, operating parts 29, 30 are respectively risen from operation openings 5C, 5D of body case 5A and again returned to a state where push operation can be performed.

It should be noted that, in the present exemplary embodiment, operating parts 29, 30 are disposed in both upper and lower portions of body case 5A. However, even when either operating part 29 or operating part 30 is disposed in at least one of the upper portion and the lower portion, a similar operation can be performed.

As described above, in the present exemplary embodiment, operating parts 29, 30 are disposed in at least one of the upper and lower portions of body case 5A. Accordingly, when the upper and lower portions of body case 5A are gripped to change a setting position of body case 5A, the setting position of body case 5A can be changed. In other words, operating parts 29, 30 are pushed into body case 5A in a state where the upper and lower portions of body case 5A are gripped. When operating parts 29, 30 are pushed into the body case, urge of urging parts 23, 24 is released. The setting position of body case 5A is changed in a state where the urge of urging parts 23, 24 is released. When the hand is released from body case 5A after the setting change, the urge of urging parts 23, 24 can be restored. In this way, the change in the setting position can be completed. The rear-view confirmation device of the present exemplary embodiment is extremely easy to use.

Regarding urging parts 23, 24, it is possible to have a configuration in which only one urging part 23 (or urging part 24) serves as an urging body, other urging part 24 (or urging part 23) serves as a hard member, and urging body 23 (or urging part 24) is pressed toward urging part 24 (or urging part 23). At this time, a position of holding part 22 (or holding part 21) is fixed.

### Second Exemplary Embodiment

Next, a rear-view confirmation device according to a second exemplary embodiment of the present invention is described with reference to FIGS. 12 to 14.

It should be noted that a difference in configuration between the rear-view confirmation device in the second exemplary embodiment and the rear-view confirmation device in the first exemplary embodiment is only rotation holding mechanism 120 installed in body case 5A. Accordingly, identical reference marks are assigned to configurations similar to the configurations of the first exemplary embodiment, and description thereof may be omitted.

### [Configuration of Rotation Holding Mechanism 120]

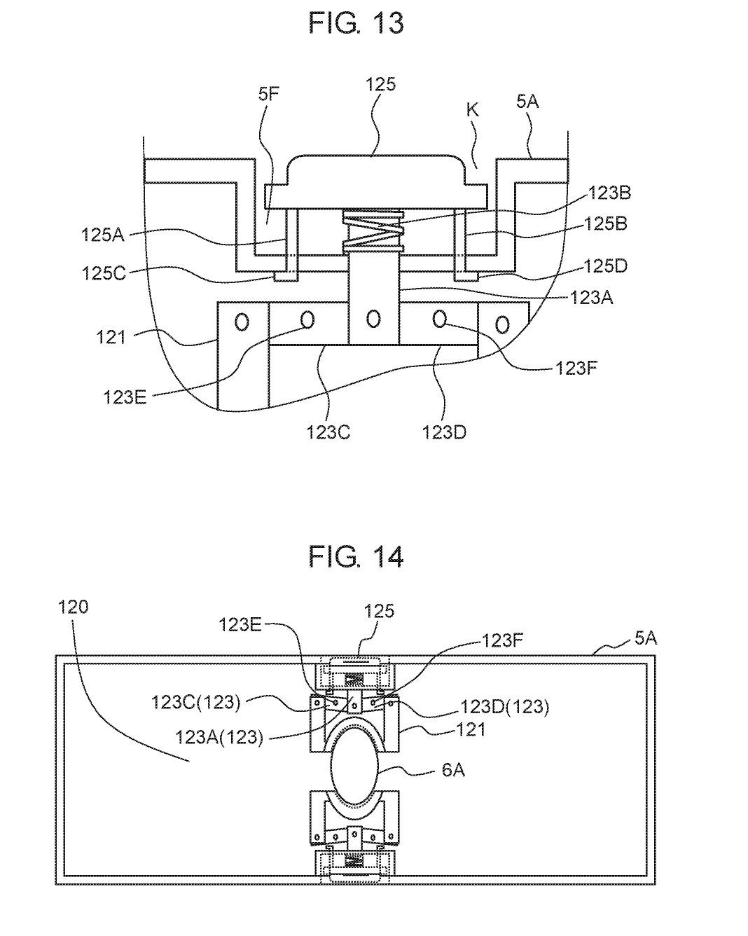

Rotation holding mechanism 120 in the second exemplary embodiment includes holding parts 121, 122, urging parts 123, 124, and operating parts 125, 126. It should be noted that details of urging part 123 are described below with reference to FIG. 13.

As shown in FIG. 12, holding parts 121, 122 are disposed on both upper and lower sides of pivot 6A, and each of holding parts 121, 122 has a shape of a curved container (a hemispherical shape). Urging parts 123, 124 respectively urge holding parts 121, 122 toward pivot 6A. Operating parts 125, 126 are respectively coupled to urging parts 123, 124, and urged toward an outside of body case 5A.

As shown in FIG. 13, urging part 123 in the present exemplary embodiment includes operating lever 123A, spring 123B, and coupling levers 123C, 123D. An upper end (a first end) of operating lever 123A is coupled to operating part 125, and a lower end (a second end) of operating lever 123A is inserted into body case 5A. Also, spring 123B is installed in the upper end (the first end) of operating lever 123A and urged toward the outside of body case. Additionally, rotation holding mechanism 120 includes right and left coupling levers 123C, 123D each having an inner end side (a first end) axially supported on the lower end (the second end) of operating lever 123A. Middle portions 123E, 123F of coupling levers 123C, 123D are axially supported on body case 5A. Further, an outer end side (a second end) of each coupling lever 123C, 123D is axially supported on holding part 121.

Moreover, as shown in FIG. 13, recess 5F depressed toward an inside of body case 5A is provided in body case 5A. Also, operating part 125 is disposed in recess 5F. Further, the other end side (the second end) of operating lever 123A is inserted into body case 5A by penetrating through a bottom surface of recess 5F. Further, auxiliary levers 125A, 125B are connected to operating part 125 and located on both sides of operating lever 123A. Also, auxiliary levers 125A, 125B are inserted into body case 5A by penetrating through the bottom surface of recess 5F. Further, coming-off regulating parts 125C, 125D are respectively provided at ends of auxiliary levers 125A, 125B. Also, coming-off regulating parts 125C, 125D abut on an inner surface of body case 5A. Further, spring 123B is disposed between operating part 125 and recess 5F.

In other words, in rotation holding mechanism 120 in the second exemplary embodiment, it is preferable that body case 5A have recess 5F. Also, operating part 125 is disposed at recess 5F. The end (the second end) of operating lever 123A is inserted into body case 5A by penetrating through recess 5F.

Moreover, it is preferable that rotation holding mechanism 120 in the second exemplary embodiment further include first and second auxiliary levers 125A, 125B connected to operating part 125. First auxiliary lever 125A and second auxiliary lever 125B are located on both the sides of operating lever 123A. Also, first auxiliary lever 125A and second auxiliary lever 125B are inserted into recess 5F, and coming-off regulating parts 125C, 125D which abut on an inner surface of recess 5F of body case 5A are provided at respective ends of first and second auxiliary levers 125A, 125B.

Moreover, it is preferable that rotation holding mechanism 120 in the second exemplary embodiment further include spring 123B installed in the end (the first end) of operating lever 123A to urge operating lever 123A toward the outside of body case 5A. Also, spring 123B is disposed between operating part 125 and recess 5F.

Further, gap K for recognizing an operating part is formed between operating part 125 and body case 5A.

Holding part 121 described above is urged toward pivot 6A via coupling levers 123C, 123D, and operating part 125 is urged upward of body case 5A.

Other urging part 124, operating part 126, and holding part 122 have configurations similar to the configurations shown in FIGS. 13 and 14, and descriptions thereof are omitted.

Further, a rough surface is provided on at least one of a surface of pivot 6A which faces holding parts 121, 122 and surfaces of holding parts 121, 122 which face pivot 6A.

### [Operation of Display Device 5]

Next, operation of display device 5 configured as described above is described.

When an angle of display device 5 relative to a driver is set, body case 5A of display device 5 is gripped with one hand from a driver's seat 3 side.

In other words, when the angle setting is performed, for example, a thumb of the hand is placed on operating part 126, a middle finger of the hand is placed on operating part 125, and operating part 126 and operating part 125 are pushed toward the inside of body case 5A.

At this time, since gap K for recognizing an operating part is formed between operating parts 125, 126 and body case 5A, gap K for recognizing an operating part can be easily found by touch. In other words, the driver can easily find operating parts 126, 126 and then push operating parts 125, 126 toward the inside of body case 5A even during driving of an automobile.

When operating parts 125, 126 are pushed toward the inside of body case 5A, as shown in FIG. 14, operating lever 123A is compressed and moved toward pivot 6A. Due to this operation, right and left coupling levers 123C, 123D move holding part 121 in a direction away from pivot 6A with middle portions 123E, 123F of coupling levers 123C, 123D axially supported on body case 5A as a fulcrum, and the urge from urging part 123 to pivot 6A is released.

Although description is omitted herein, urging part 124 (see FIG. 12) acts similarly to urging part 123. Body case 5A can be freely rotated relative to pivot 6A, and the angle of display device 5 relative to the driver can be easily set.

Then, when the angle setting of display device 5 ends, the hand which grips body case 5A is released. In that case, operating lever 123A of urging part 123 is extended and moved outward of the body case by an urging force of spring 123B. As a result, right and left coupling levers 123C, 123D move holding part 121 in a direction toward pivot 6A with middle portions 123E, 123F of right and left coupling levers 123C, 123D axially supported on body case 5A as a fulcrum. Accordingly, holding part 21 is pressed against pivot 6A by urging part 23. Urging part 124 also acts similarly. Thereafter, body case 5A is not easily moved by a vibration or an impact.

Operating parts 125, 126 are respectively moved in vertical directions by spring 123B, and then returned to an original state shown in FIG. 12.

As described above, in the present exemplary embodiment, operating parts 125, 126 are disposed in upper and lower portions of body case 5A. Accordingly, when the upper and lower portions of body case 5A are gripped to change a setting position of body case 5A, operating parts 125, 126 are pushed into body case 5A in this state, and the urge of urging parts 123, 124 can be released. Next, the setting position of body case 5A is changed in a state where the urge of urging parts 123, 124 is released. When the hand is released after the setting change, the urge of urging parts 123, 124 can be restored. In this way, the change in the setting position can be completed. As is obvious from the above description, the rear-view confirmation device of the present exemplary embodiment is extremely easy to use.

It should be noted that operating parts 125, 126 are disposed on the upper and lower sides in the aforementioned exemplary embodiment. However, even when operating parts 125, 126 are disposed in at least one of the upper and lower sides, a similar operation can be performed.

Further, regarding urging parts 123, 124, it is possible to have a configuration in which only one urging part 123 (or urging part 124) serves as an urging body, the other urging part serves as a holding portion, and one urging body 123 (or urging part 124) is pressed against other holding part 122 (or holding part 121).

It should be noted that in the first exemplary embodiment described with reference to FIG. 10, operating part 29 or the like may have a configuration shown in FIG. 13. Similarly, in the second exemplary embodiment described with reference to FIG. 12, operating part 125 or the like may have a configuration shown in FIG. 11.

### INDUSTRIAL APPLICABILITY

In the present invention, the operating part is disposed in at least one of the upper and lower portions of the body case. Accordingly, when the upper and lower portions of the body case are gripped, the urge of the urging part is released, and the setting position of the body case can be changed. Further, when the driver releases his/her hand, the urge by the urging part is restored, and the change of the setting position can be completed. The rear-view confirmation device which is extremely easy to use can thus be provided.

Further, utilization of the rear-view confirmation device and the automobile equipped with the same is expected.

### REFERENCE MARKS IN THE DRAWINGS

1: automobile
2: interior
3: driver's seat
4: assistant driver's seat
5: display device
5A: body case
5B: display opening
5C, 5D: operation opening
5F: recess
6: mounting member
6A: pivot
7: display
8: camera device
9: backlight
10: liquid crystal display
11, 18: controller
12, 17: transmitter
13, 16: receiver
14: storage
15, 29, 30, 125, 126: operating part
19: imaging element
20, 120: rotation holding mechanism
21, 22, 121, 122: holding part
23, 24, 123, 124: urging part
25, 26, 27, 28: coupling part
29A: large diameter portion
29B: small diameter portion
31, 32: regulating part
50: opening
123A: operating lever
123B: spring
123C, 123D: coupling lever
123E, 123F: middle portion
125A, 125B: auxiliary lever
125C, 125D: regulating part
K: gap

1. A rear-view confirmation device comprising:
a display device mounted in front of a driver's seat in an interior of an automobile;
a mounting member for mounting the display device in the front of the driver's seat; and
a camera device connected to the display device and capable of capturing a rear video image of the automobile,
wherein the display device includes:
a body case having an opening on a driver's seat side;
a display disposed so as to cover the opening of the body case; and
a rotation holding mechanism installed inside the body case,
the mounting member includes a pivot disposed inside the body case,
the rotation holding mechanism includes:
a holding part disposed on a side surface of the pivot;
an urging part for urging the holding part toward the pivot;
a coupling part coupled to the urging part and configured to release urging of the urging part toward the pivot; and
an operating part coupled to the coupling part and urged from an inside of the body case to an outside of the body case by the coupling part, and
the operating part is capable of performing push operation from the outside of the body case to the inside of the body case via an operation opening provided in at least one of upper and lower portions of the body case.

2. The rear-view confirmation device according to claim 1, wherein
the holding part includes a first holding part and a second holding part,
the urging part includes a first urging part and a second urging part,
the coupling part includes a first coupling part and a second coupling part,
the operating part includes an upper operating part and a lower operating part,
the operation opening includes an upper operation opening and a lower operation opening,
the first urging part urges the first holding part toward the pivot, and the second urging part urges the second holding part toward the pivot,
the first coupling part is coupled to at least one of the first urging part and the second urging part, and is coupled to the upper operating part,
the second coupling part is coupled to at least one of the first urging part and the second urging part, and is coupled to the lower operating part,
the upper operating part penetrates through the upper operation opening and is capable of being operated in a vertical direction,
the lower operating part penetrates through the lower operation opening and is capable of being operated in the vertical direction,
the upper operating part is urged upward by at least one of the first urging part and the second urging part via the first coupling part, and
the lower operating part is urged downward by at least one of the first urging part and the second urging part via the second coupling part.

3. The rear-view confirmation device according to claim 1, wherein
the operating part includes:
a large diameter portion located inside the body case; and
a small diameter portion coupled to the large diameter portion and which protrudes from the inside of the body case by penetrating through the operation opening,
an outer peripheral surface of the small diameter portion is a curved surface, and
a gap is provided between an inner peripheral surface of the operation opening and the small diameter portion.

4. A rear-view confirmation device comprising:
a display device mounted in front of a driver's seat in an interior of an automobile;
a mounting member for mounting the display device in the front of the driver's seat; and
a camera device connected to the display device and capable of capturing a rear video image of the automobile,
wherein the display device includes:
a body case having an opening on a driver's seat side;
a display disposed so as to cover the opening of the body case; and
a rotation holding mechanism installed inside the body case,
the mounting member includes a pivot disposed inside the body case,
the rotation holding mechanism includes:
a holding part disposed in at least one of upper and lower portions of the pivot;
an urging part for urging the holding part toward the pivot; and
an operating part coupled to the urging part and urged from an inside of the body case to an outside of the body case by the urging part,
the urging part includes:
an operating lever having a first end coupled to the operating part and a second end inserted into the body case;
a first coupling lever having a first end axially supported by the second end of the operating lever; and
a second coupling lever having a first end axially supported by the second end of the operating lever,
a middle portion of the first coupling lever and a middle portion of the second coupling lever are axially supported by the body case, and
the second end of the first coupling lever and the second end of the second coupling lever are axially supported by the holding part.

5. The rear-view confirmation device according to claim 4, wherein
the body case has a recess,
the operating part is disposed in the recess, and
the second end of the operating lever is inserted into the body case by penetrating through the recess.

6. The rear-view confirmation device according to claim 5, further comprising a first auxiliary lever and a second auxiliary lever which are connected to the operating part,
wherein the first auxiliary lever and the second auxiliary lever are located on both sides of the operating lever, and inserted into a bottom surface of the recess, and
a coming-off regulating part which abuts on an inner surface of the recess of the body case is provided at each end of the first and second auxiliary levers.

7. The rear-view confirmation device according to claim 5, further comprising a spring installed at the first end of the operating lever and configured to urge the operating lever toward the outside of the body case,
wherein the spring is disposed between the operating part and the recess.

8. The rear-view confirmation device according to claim 1, wherein a rough surface is provided on at least one of a surface of the pivot which faces the holding parts and a surface of the holding part which faces the pivot.

9. An automobile comprising:
the rear-view confirmation device according to claim 1,
wherein the camera device is disposed in a rear of an interior or an exterior of the automobile.

10. The rear-view confirmation device according to claim 2, wherein
the operating part includes:
a large diameter portion located inside the body case; and
a small diameter portion coupled to the large diameter portion and which protrudes from the inside of the body case by penetrating through the operation opening,
an outer peripheral surface of the small diameter portion is a curved surface, and
a gap is provided between an inner peripheral surface of the operation opening and the small diameter portion.

11. The rear-view confirmation device according to claim 6, further comprising a spring installed at the first end of the operating lever and configured to urge the operating lever toward the outside of the body case,
wherein the spring is disposed between the operating part and the recess.
